(19) United States
(12) Patent Application Publication
(10) Pub. No.: US 2018/0162424 A1
(43) Pub. Date: Jun. 14, 2018

(54) RAILWAY CAR TRUCK FRICTION SHOE

(71) Applicant: Amsted Rail Company, Inc., Chicago, IL (US)

(72) Inventors: Igor Aleynikov, St. Louis, MO (US); Jay P. Monaco, Glen Carbon, IL (US); Shawn Peetz, Troy, IL (US); Tom Petrunich, Troy, IL (US); Ralph Schorr, Edwardsville, IL (US); Paul Steven Wike, St. Louis, MO (US)

(21) Appl. No.: 15/375,887

(22) Filed: Dec. 12, 2016

(51) Int. Cl. B61H 5/00; B61F 5/52; F16D 65/06

(52) U.S. Cl. CPC B61H 5/00; F16D 65/062; B61F 5/52

(57) ABSTRACT

A friction shoe for a railway car truck is provided. The railway truck comprises two parallel sideframes, a suspension spring assembly supported by the sideframes, and a bolster transversely mounted between the sideframes and supported by the suspension spring assembly. Each sideframe has at least one vertical support face, and the bolster has at least one sloped support face. The friction shoe comprises a bottom base engaging and supported by a suspension control spring, a sloped face engaging the sloped wall of the bolster. The friction shoe further includes a vertical face including a pocket, with a friction liner in the pocket. The friction liner engaging the vertical column of the sideframe. The friction shoe friction liner comprised of a material providing a damping force of between 700 and 16,250 pounds and a normal force of between 2000 and 12,000 pounds.

### BACKGROUND AND SUMMARY OF THE INVENTION

The invention relates generally to railway car truck friction damping arrangements, and more particularly to a railway car truck friction shoe.

The present invention is directed to a friction wedge or shoe for a railroad car truck and in particular to a friction shoe including a body having a sloped face and a vertical face. The vertical face includes an indentation or pocket over most of its surface. A generally planar friction liner is inserted into the pocket. The friction liner is bonded to the friction shoe body.

The friction liner is usually comprised of a rigid molded material having selected friction characteristics. Such friction characteristics include a consistent friction coefficient with a small difference between static and dynamic friction. The total energy dissipation of the friction liner and thusly the friction shoe is greater than in prior friction shoes. The friction shoe dissipates greater energy throughout the range of suspension travel and friction shoe and bolster velocities moving vertically along the sideframe column wear plate.

Railroad car trucks of a design known as a three piece railway car truck include a pair of spaced apart side frames and a bolster that extends transversely between the side frames. The bolster is resiliently supported at each end on a respective side frame by a plurality of suspension springs comprised of a combination of load and control springs. Wedge shaped friction shoes are used in such railroad car trucks to dampen movement of the bolster with respect to the side frame of the railroad car truck. Friction shoes are usually generally triangular wedge shaped such that the friction shoe sloped face in contact with a sloped wall of the bolster pocket can act as a motion damping wedge between the bolster and a wear plate on a vertical column of the side frame.

The column wear plate on the side frame vertical column is usually comprised of steel. The friction shoe is wedged into engagement between a sloped wall of the bolster pocket and the side frame vertical column by a suspension control spring. Resistance to sliding movement of the friction shoe with respect to the side frame, which in turn provides dampening of vertical bolster movement, is provided by the frictional forces generated between the friction shoe and the column wear plate on the side frame vertical column.

It is an object of the present invention to provide an improved railway car truck friction shoe that, with a rigid molded friction liner, the damping frictional force on the vertical movement of the bolster is better controlled with greater energy dissipation.

### BRIEF DESCRIPTION OF THE DRAWING FIGURES

FIG. 1 is an exploded perspective view of a railway car truck in accordance with an embodiment of the present invention;

FIG. 2 is a detailed partial perspective view of a portion of a railway car truck in accordance with an embodiment of the present invention;

### DETAILED DESCRIPTION OF THE PREFERRED EMBODIMENT

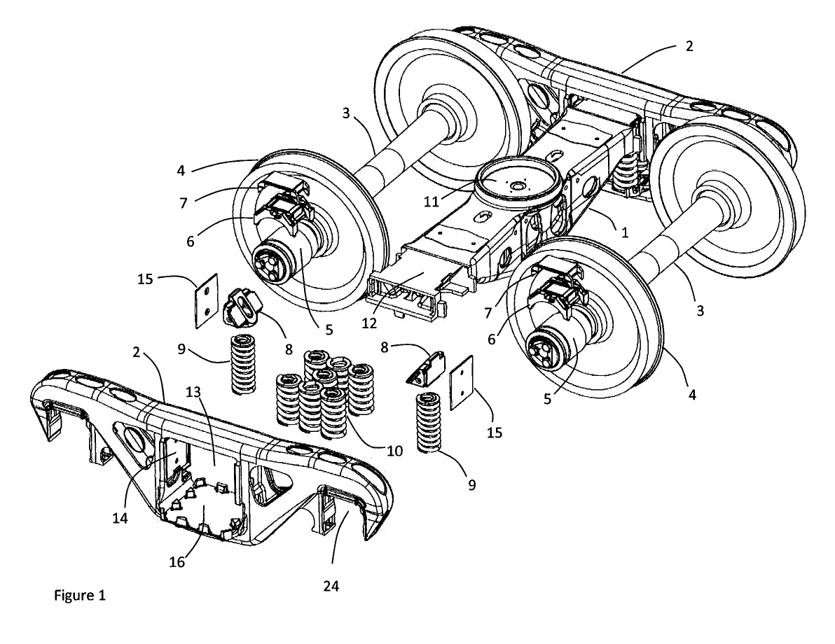

Referring now to FIG. 1, a friction shoe 8 of the present invention is shown in a railroad car truck. The railway car truck includes two side frames 2 which are spaced apart and generally parallel to one another. Each side frame 2 includes a window 13 formed by a pair of spaced apart vertical columns 14. A planar column wear plate 15 is connected to the interior surface of each side frame vertical column 14. The railway car truck also includes a bolster 1 which extends generally transversely between the side frames 2. Each end 12 of the bolster 1 is located within a respective side frame window 13 and is vertically supported on a side frame 2 by a plurality of helical coil suspension load springs 10. Suspension load springs 10 are themselves supported on a spring seat 16 of each sideframe 2. Suspension load springs 10 are resiliently compressible to thereby allow the ends of the bolster 1 to move vertically upwardly and downwardly within the windows 13 and with respect to the side frames 2. Each bolster end 12 includes a plurality of sloped walls 23. Each sloped wall 23 is adapted to engage a sloped face 20 of a respective friction shoe 8. Friction shoe 8 is seen to provide a damping force to the vertical motion of bolster 1 while supported on suspension control springs 9 as the railway car travels on the rails. Suspension control springs 9 are also supported on the spring seat 16 of each sideframe 2.

Railway wheels 4 are mounted on axles 3. Axle bearings 5 are mounted on the ends of axles 3. Bearing spacer 6 and spacer pad 7 are provided to receive axle bearings in sideframe pedestal openings 24. Center bowl 11 on the top surface of bolster 1 is provided to help support the railway freight car on the truck.

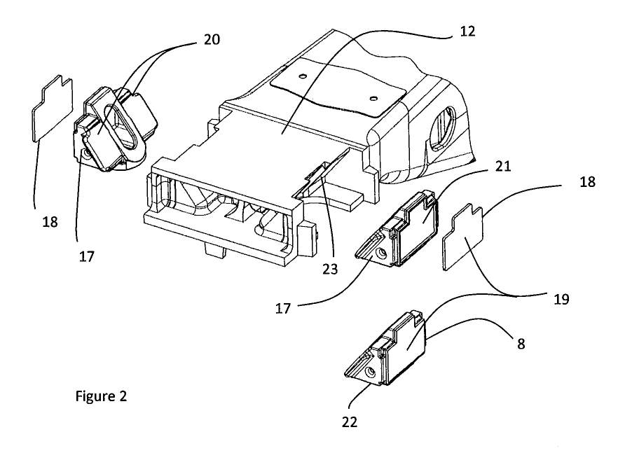

As best shown in FIG. 2, Friction shoe 8 includes a body 17 and a friction liner 18. The friction shoe body 17 includes a generally vertical liner pocket 21 that is adapted to receive the friction liner 18. The friction liner 18 functions as the vertical face 19 of the friction shoe 8. The friction shoe body 17 is generally triangular or wedge-shaped. The friction shoe body 17 includes a base having a generally horizontal bottom surface 22. The bottom surface 22 is adapted to engage the top end of a suspension control spring 9. The friction shoe body 17 also includes a sloped face 20 that extend at an inclined angle between the bottom surface 22 and the vertical face 19. Friction shoe sloped faces 20 are adapted to engage the sloped walls 23 of the bolster 1.

Friction shoe friction liner material of choice is RF-55 from Scan-Pac Manufacturing.

The damping force by the friction shoe friction liner material can vary as may be selected from the various materials for friction liner 18 and the thickness of friction liner 18 and degree the vertical face is impinged against side frame column wear plate 15 and the angle of the bolster pocket slope wall 23.

Such damping forces can vary from 700 to 16,250 pounds with a velocity range of movement of the friction shoe friction liner of between 0 and 19 inches per second.

Normal force to the friction liner 18 can vary from 2000 to 12,000 pounds.

What is claimed is:

1. A friction shoe for a railway car truck,
the railway car truck comprising
two parallel sideframes, a suspension spring assembly supported by the sideframes, and a bolster transversely mounted between the sideframes and supported by the suspension spring assembly,
each sideframe having at least one vertical column,
the bolster having at least one sloped wall,
the friction shoe comprising:
a bottom surface engaging and supported by a suspension control spring,
a sloped face engaging the sloped wall of the bolster,
and a vertical face including a liner pocket,
a friction liner bonded in the liner pocket on the vertical face of the friction shoe,
the friction liner engaging the vertical column of the sideframe,
the friction shoe friction liner provides a damping force of between 7500 and 16,250 pounds when the friction shoe is moving downward at a velocity of between 0 and 19 inches per second.

2. The friction shoe of claim 1 wherein
the friction shoe friction liner comprised of a material providing a normal force of between 2000 and 12,000 pounds.

3. The friction shoe of claim 1 wherein
the friction liner is a molded material such as RF-55.

4. The friction shoe of claim 1 wherein
the friction liner is comprised of one or more of the following:
carbon/graphite, ceramic, or polymer blend material.

5. The friction shoe of claim 1 wherein
the friction liner is comprised of sintered iron or alloyed steel.

6. The friction shoe of claim 1 wherein
the friction liner is bonded without a pocket on the friction shoe body or un-bonded with a pocket in the friction shoe body.

7. A friction shoe for a railway car truck,
the railway car truck comprising
two parallel sideframes, a suspension spring assembly supported by the sideframes, and a bolster transversely mounted between the sideframes and supported by the suspension spring assembly,
each sideframe having at least one vertical column,
the bolster having at least one sloped wall,
the friction shoe comprising:
a bottom surface engaging and supported by a suspension control spring,
a sloped face engaging the sloped wall of the bolster,
and a vertical face including a liner pocket,
a friction liner bonded in the liner pocket on the vertical face of the friction shoe,
the friction liner engaging the vertical column of the sideframe,
the friction shoe friction liner comprised of a material providing a damping force of between 700 and 10,000 pounds when the friction shoe is moving upward at a velocity of between 0 and 19 inches per second.

8. The friction shoe of claim 145 wherein
the friction shoe friction liner comprised of a material providing a normal force of between 2000 and 12,000 pounds.

9. The friction shoe of claim 1 wherein
the friction liner is a molded material such as RF-55.

10. The friction shoe of claim 7 wherein
the friction liner is comprised of one or more of the following:
carbon/graphite, ceramic, or polymer blend material.

11. The friction shoe of claim 7 wherein
the friction liner is comprised of sintered iron or alloyed steel.

12. The friction shoe of claim 7 wherein
the friction liner is bonded without a pocket on the friction shoe body or un-bonded with a pocket in the friction shoe body.
